(19) United States
(12) Patent Application Publication
(10) Pub. No.: US 2005/0056982 A1
(43) Pub. Date: Mar. 17, 2005

(54) Vibration damping device having rubber support

(75) Inventor: Koichi Hasegawa, Kasugai-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., Komaki-shi (JP)

(21) Appl. No.: 10/936,514

(22) Filed: Sep. 9, 2004

(30) Foreign Application Priority Data
Sep. 16, 2003 (JP) 2003-323625

(51) Int. Cl. F16F 5/00

(52) U.S. Cl. 267/140.13

(57) ABSTRACT

A vibration damping device including a rubber elastic body elastically connecting a first and second mounting members; a support member fixedly assembled with a lower open end of a cylindrical portion of the second mounting member; and a central rubber support disposed within a hollow portion of the second mounting member while extending in an axial direction of the second mounting member and being compressed between opposite faces of the first mounting member and the support member. The central rubber support is superimposed in a non-bonded state at at least one end face thereof against an axially opposing member with a generally flat face extending in a perpendicular direction to a direction in which the first mounting member and the support member are opposed to each other, and is not bonded to any other member over its entire outer circumferential surface.

### INCORPORATED BY REFERENCE

The disclosure of Japanese Patent Application No. 2003-323625 filed on Sep. 16, 2003 including the specification, drawings and abstract is incorporated herein by reference in its entirety.

### BACKGROUND OF THE INVENTION

1. Field of the Invention

The present invention relates to a vibration damping device composed of two mounting members connected together by means of a rubber elastic body, which may be used as an engine mount for automotive vehicles.

2. Description of the Related Art

JP-B2-7-33857 (FIGS. 1 and 3) discloses a known example of such a vibration damping device in which an upper mounting member and a lower mounting member, which are formed of metallic flat plates, are disposed to be mutually spaced away from each other, and are elastically connected to each other by means of a rubber elastic body of thick-walled configuration interposed therebetween. This vibration damping device is installed on an automotive vehicle with the lower mounting member fixed to a body side and the upper mounting member fixed to an engine side. This vibration damping device is capable of exhibiting an enhanced spring constant in the vertical direction, i.e., a vibration input direction, with a simple construction. Thus, the vibration damping device will provide excellent vibration damping effect with respect to low frequency engine shakes, for example.

In the known vibration damping device, due to the thick walled configuration of the rubber elastic body, the spring stiffness inevitably increases not only in the vertical direction but also in the traveling and lateral directions of the vehicle. This may creates a problem of uncomfortable driving due to undesirable transmission of engine idling vibration whose frequency in higher than that of the engine shake vibration. Besides, the flat plate upper and lower mounting members overall require a relatively large space for installation, making it difficult to arrange the vibration damping device within a vehicle engine room or a limited installation space where is limited a space utilization.

### SUMMARY OF THE INVENTION

It is therefore one object of this invention to provide a vibration damping device of simple construction that is capable of exhibiting an enhanced or increased spring constant in a vibration input direction, while avoiding or minimizing increase in its spring constant in a direction orthogonal to the vibration input direction, and that requires a relatively small installation space.

The above and/or other objects may be attained according to at least one of the following aspects of the invention. The following preferred forms of the respective aspects of the invention may be adopted at any possible optional combinations. It is to be understood that the present invention is not limited to the following forms or combinations of these forms, but may otherwise be recognized based on the thought of the present invention that described in the whole specification and drawings or that may be recognized by those skilled in the art in the light of the disclosure in the whole specification and drawings.

The above object may be achieved according to the principle of the present invention, which provides a vibration damping device interposed between two members of a vibration system, comprising: (a) a first mounting member fixable to one of the two members of the vibration system; (b) a second mounting member fixable to an other of the two members of the vibration system, and having a hollow cylindrical portion that is substantially concentrically disposed to and spaced away from the first mounting member in a vibration input direction; (c) a rubber elastic body interposed between and elastically connecting the first and second mounting member such that a fluid-tight closure is provided to one open end of the cylindrical portion of the second mounting member, and a hollow portion extends from the rubber elastic body to an other open end of the cylindrical portion within the second mounting member, the rubber elastic body having a tapered outer circumferential surface whose diameter is gradually decreasing as it moves from the one open end of the cylindrical portion of the second mounting member toward the first mounting member; (d) a support member fixedly assembled with the second mounting member from a side of the other open end of the cylindrical portion of the second mounting member so as to extend in an axis-perpendicular direction of the second mounting member; and (e) a central rubber support disposed within the hollow portion of the second mounting member such that the central rubber support extends in an axial direction of the second mounting member and is compressed between opposite faces of the first mounting member and the support member, wherein at least one of axially opposite end faces of the central rubber support is superimposed in a non-bonded state against an axially opposing member with a generally flat face thereof extending in a perpendicular direction to a direction in which the first mounting member and the support member are opposed to each other, and wherein an outer circumferential surface of the central rubber support is not bonded to any other member over an entire axial length thereof.

In the vibration damping device of construction according to the present invention, the central rubber support disposed within the hollow portion of the second mounting member and the rubber elastic body are arranged in series in the vibration input direction, i.e., in the axial direction of the device, so that the vibration damping device will exhibit a spring constant considerably higher than does the conventional vibration damping device having no central rubber support disposed within the hollow portion of the second mounting member. In addition, since the central rubber support undergoes shear deformation during input of vibrational load in all axis-perpendicular direction of the device, the presence of the central rubber support will not impact on the spring constant of the vibration damping device in the axis perpendicular direction, whereby the vibration damping device is able to keep its spring constant in the axis-perpendicular direction lower, while increasing its spring constant in the axial or vibration input direction. Moreover, the central rubber support is disposed by effectively utilizing a hollow space of the second mounting member, so that the overall size or a required installation space of the vibration damping device is effectively minimized, while achieving desired spring constants thereof in the axial and axis-perpendicular directions.

It should be appreciated that the central rubber support may be formed independently of any other components of the invention, or alternatively may be integrally bonded to either the support member or the first mounting member directly or indirectly, e.g., via the rubber elastic body, for example. The present invention includes a vibration damping device having a plurality of central rubber supports.

It should also be appreciated that since the outer circumferential surface of the central rubber support is not bonded to any other member over its entire axial length, the outer circumferential surface of the central rubber support serves as a free surface. This arrangement prevent the central rubber support from being excessively restricted in its elastic deformation, thereby effectively avoiding increase in the spring constant of the vibration damping device in the axis-perpendicular direction. Meant by the free surface includes the outer circumferential surface of the central rubber support exposed to a space, and the outer circumferential surface of the central rubber support contact with but not bonded to the inner circumferential surface of the hollow portion, as well.

While the rubber elastic body has the outer circumferential surface of tapered configuration in order to decrease its spring constant in the axis perpendicular direction as much as possible, this arrangement may give rise to a likelihood of a local bulking of the rubber elastic body during input of vibration in the axial direction of the vehicle. Namely, the elastic body has a resistance to bulking that is influenced by a ratio of its outside dimension to its axial dimension, and a wall thickness dimension thereof (an effective wall thickness dimension), as well. Besides, the following are effective majors in order to decrease the spring constant in the axis-perpendicular direction of the rubber elastic body: (a) to decrease the ratio of the outside dimension to the axial dimension by largely protruding the rubber elastic body in the axial direction from the second mounting member to the first mounting member, and (b) to form a large-diameter recess of inverted motor shape open in a large-diameter end face of the rubber elastic body. However, these effective majors are more likely cause a problem of bulking of the rubber elastic body. The bulking of the rubber elastic body may create an irregular deformation of the rubber elastic body, undesirably causing significant change in spring characteristics of the vibration damping device, as well as a local stress concentration and a resultant considerable deterioration in durability of the rubber elastic body. With this regards, the present invention employs the aforementioned unique structure capable of increasing the spring stiffness in the axial direction, while preventing adverse impact on the spring characteristics in the axis-perpendicular direction. In the present invention, therefore, if the rubber elastic body takes the form according to the aforesaid majors (a) and/or (b) in order to decrease its spring constant in the axis-perpendicular direction, it is possible to advantageously realize low dynamic spring constant of the vibration damping device in its axis-perpendicular direction to enhance damping performance with respect to vibration in the axis-perpendicular direction, while preventing bulking of the rubber elastic body with respect to axial load to stably exhibit spring characteristics of the device and to assure excellent durability of the device.

Further, the central rubber support is disposed in a compression state between the first mounting member and the support member in the axial direction of the vibration damping device. This arrangement is effective to prevent or minimize fatigue of the central rubber support due to an initial load applied thereto when being installed on the vehicle. Moreover, if the central rubber support is just held in abutting contact with the first mounting member and/or the support member, or is spaced away from any one of these members, before installation, the central rubber support is more likely undergo repeated impact against or rubbed with the opposing member in the axial direction, causing undesirable noises or abrasions. With input load in the rebound direction taken into consideration, a somewhat compression is needed to prevent frequent impact of the rubber elastic body against the opposing member or members.

According to one preferred form of the invention, wherein an other one of axially opposite end faces of the central rubber support is integrally bonded to one of the first mounting member and the support member. In the case where the central rubber support is integrally bonded to the first mounting member directly or via the rubber elastic body, the central rubber support and the rubber elastic body may be formed integrally through a single vulcanization process of a rubber material, making it easy to manufacture and assemble the present vibration damping device. When the central rubber support is integrally bonded to the support member, the central rubber support may be integrally bonded to a surface of the support member that is fixed to the second mounting member, and then fixedly fitted into the hollow portion of the second mounting member. For instance, the one of axially opposite end faces of the central rubber support is superimposed in the non-bonded state against the first mounting member via the rubber elastic body, and the other one of axially opposite end faces of the central rubber support is integrally bonded to the support member. The support member may have a variety of configurations.

With these arrangements, for producing the vibration damping device of the present invention, it is possible to utilize an intermediate integral vulcanization product of a known fluid-filled vibration damping device, which comprises a first mounting member, a cylindrical second mounting member spaced away from the first mounting member in a vibration input direction, and a rubber elastic body interposed between and elastically connecting the first and second mounting members so as to form a hollow portion as a fluid-sealing area inside the second mounting member. Namely, the central rubber support integrally bonded to the support member is disposed within the hollow portion of the second mounting member and affixed to the other or vertically lower open end of the cylindrical portion of the second mounting member, thereby providing a vibration damping device of construction according to the present invention. That is, the present vibration damping device can readily utilize the intermediate integral vulcanization produce of the fluid-filled vibration damping device without needing a change in its design or arrangement, ensuring a convenient component share between the present invention and the conventional fluid-filled vibration damping device. Further, by only changing a shape and/or material of the central rubber support, it is possible to suitably change the spring characteristics of the vibration damping device depending on applications of the devices. The support member may be at least partially defined by the other member of the vibration system.

Preferably, the support member is formed of a disk shaped plate member of metal, and the support member is secured press-fit into the cylindrical portion of the second mounting member via a rubber coating layer. This arrangement makes it easy to manufacture the support base by pressing or the like, and a presence of the rubber coating layer in between the cylindrical portion of the second mounting member and the support base permits a suitable dimensional tolerance of the support base.

According to yet still another preferred form of the invention, a radial spacing is formed between the outer circumferential surface of the central rubber support and the inner circumferential surface of the hollow portion of the second mounting member. This arrangement is effective to prevent undesirable rubbing between the outer circumferential surface of the central rubber support and the inner circumferential surface of the rubber elastic body, thereby preventing possible noises or defects of these two members.

According to a further preferred form of the invention, wherein the rubber elastic body has a generally frustoconical configuration having a recess open in a large-diameter end portion thereof, and is bonded at a small diameter end portion thereof to the first mounting member, and at an outer circumferential surface of the large-diameter end portion thereof to an inner circumferential surface of the cylindrical portion of the second mounting member such that the recess partially defines the hollow portion of the second mounting member, the central rubber support being disposed within the recess with a radial spacing between the outer circumferential surface of the central rubber support and the inner circumferential surface of the hollow portion over an entire axial length of the central rubber support. According to this arrangement, the central rubber support is installed within the hollow portion of the second mounting member with high space utilization by effectively utilizing the recess of the rubber elastic body. For instance, the space to be utilized as a fluid chamber may be utilized as a space for housing the central rubber support in the present vibration damping device.

In this preferred form, the central rubber support may have a pillar configuration, preferably. More preferably, the central rubber support may have a tapered pillar configuration, or alternatively have a frustoconical configuration. The central rubber support of pillar configuration is more likely to exhibit a relatively low spring constant in the axis-perpendicular direction. For instance, a round-pillar or cylindrical central rubber support exhibits a ratio of the spring constant (P) in a compression or axial direction to the spring constant (Q) in a share or axis-perpendicular direction is about P:Q=1:0.2. Further, the tapered or frustoconical central rubber support is able to stability in receiving load in the axial direction, i.e., in the vibration input direction. In addition, the frustoconical central rubber support is capable of exhibiting an generally constant spring characteristics in every diametric directions.

According to a still further preferred form of the invention, the vibration damping device further comprises an other central rubber support disposed within the hollow portion of the second mounting member such that the other central rubber support extends in an axial direction of the second mounting member and is compressed between opposite faces of the first mounting member and the support member, wherein the central rubber support and the other central rubber support are integrally bonded at first axial end faces thereof to and project from the first mounting member and the support member, respectively, and are superimposed against together at second axial end faces thereof in the non-bonded state. This arrangement permits the same advantages of the invention as stages above.

According to a yet further preferred form of the invention, the second mounting member is bonded to the other of the two members of the vibration system via a bracket. This arrangement stable and readily fixation of the vibration damping device to the other one of the two members of the vibration system, for instance, when the second abutting face on the side of the second mounting member is directly defined by the other one of the two members of the vibration system, and the central rubber support is directly held in abutting contact with the other one of the two members of the vibration system.

The principle of the present invention also provides a combination type vibration damping device for automotive vehicles requiring different damping characteristics, wherein a common integral vulcanization product defined by a following (A) is combined with selected one of a first unit defined by a following (B) and a second unit defined by a following (C), depending on the required damping characteristics of the vehicles to which the vibration damping device is installed: (A) the common integral vulcanization product including a first mounting member, a second mounting member having a hollow cylindrical portion that is substantially concentrically disposed to and spaced away from the first mounting member in a vibration input direction, and a rubber elastic body interposed between and elastically connecting the first and second mounting members such that a fluid-tight closure is provided to one open end of the cylindrical portion of the second mounting member, and a hollow portion extends from the rubber elastic body to an other open end of the cylindrical portion within the second mounting member, the rubber elastic body having a tapered outer circumferential surface whose diameter is gradually decreasing as it moves from the one open end of the cylindrical portion of the second mounting member toward the first mounting member; (B) the first unit including a support member fixedly assembled with the second mounting member from a side of the other open end of the cylindrical portion of the second mounting member so as to extend in an axis-perpendicular direction of the second mounting member; and a central rubber support disposed within the hollow portion of the second mounting member such that the central rubber support extends in an axial direction of the second mounting member and is compressed between opposite faces of the first mounting member and the support member, at least one of axially opposite end faces of the central rubber support being superimposed in a non-bonded state against an axially opposing member with a generally flat face thereof extending in a perpendicular direction to a direction in which the first mounting member and the support member are opposed to each other, and an outer circumferential surface of the central rubber support being not bonded to any other member over an entire axial length thereof, and (C) the second unit including a flexible layer fluid-tightly closing the other open end of the cylindrical portion of the second mounting member to thereby form a fluid chamber filled with a non-compressible fluid within the second mounting member by utilizing the hollow portion, a partition member extending in the axis-perpendicular direction of the second mounting member and supported by the second mounting member such that the partition member partitions the fluid chamber into a pressure receiving chamber partially defined by the rubber elastic body and an equilibrium chamber partially defined by the flexible layer, and an orifice passage for fluid communication between the pressure receiving chamber and the equilibrium chamber. According to this form of the invention, it is possible to share a common component and a production line between two types of vibration damping devices without needing a change in design and arrangement.

### BRIEF DESCRIPTION OF THE DRAWINGS

The forgoing and/or other objects features and advantages of the invention will become more apparent from the following description of a preferred embodiment with reference to the accompanying drawings in which like reference numerals designate like elements and wherein:

FIG. 1 is an elevational view in axial or vertical cross section of a vibration damping device in the form of an engine mount of construction according to one preferred embodiment of the invention;

FIG. 2 is an axial cross sectional view of a mount body of the engine mount of FIG. 1;

FIG. 3 is an axial cross sectional view of a support member of the engine mount of FIG. 1;

FIG. 4 is an elevational view in axial or vertical cross section of a vibration damping device in the form of an engine mount of construction according to another preferred embodiment of the invention;

FIG. 5 is an axial cross sectional view of a mount body of the engine mount of FIG. 4;

FIG. 6 is an axial cross sectional view of a support member of the engine mount of FIG. 4;

FIG. 7 is an elevational view in axial or vertical cross section of a vibration damping device in the form of an engine mount of construction according to yet another preferred embodiment of the invention;

FIG. 8 is an axial cross sectional view of a mount body of the engine mount of FIG. 7;

FIG. 9 is an axial cross sectional view of a support member of the engine mount of FIG. 7; and

FIG. 10 is an elevational view in axial or vertical cross section of a vibration damping device of fluid-filled type.

### DETAILED DESCRIPTION OF PREFERRED EMBODIMENTS

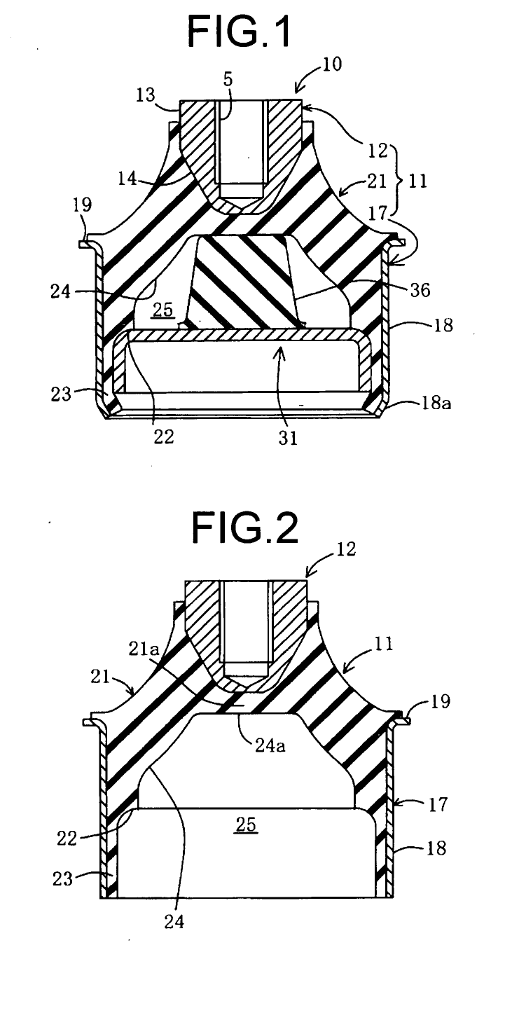

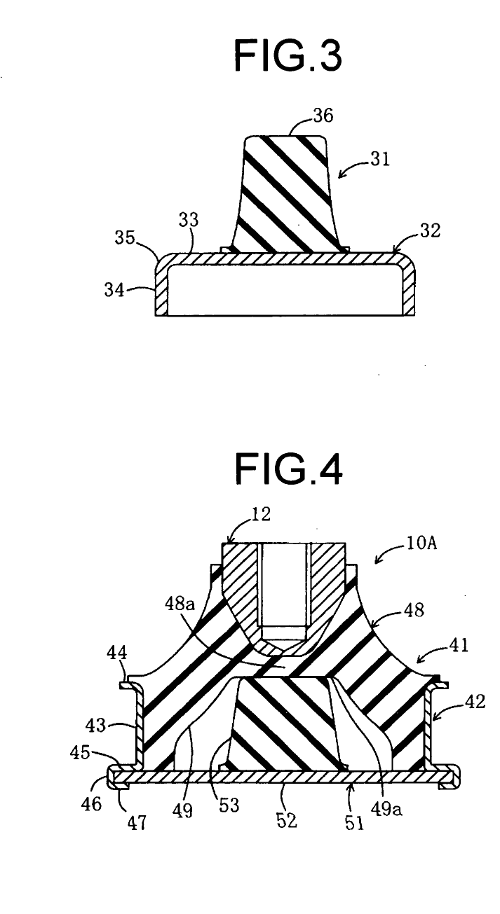

Referring first to FIG. 1, there is shown in axial cross section a vibration damping device 10 in the form of an engine mount for use in automotive vehicles, which is constructed according to a first embodiment. FIGS. 2 and 3 show in axial cross section a mount body and a support member of the vibration damping device 10.

The vibration damping device 10 comprises a mount body 11 (see FIG. 2) and a support member 31 (see FIG. 3). The mount body 11 includes a first mounting member in the form of a metallic mount fixture 12, a second mounting member in the form of a metallic body fixture 17 of round cylindrical configuration, which is coaxially or concentrically disposed about the mount fixture 12 and is downwardly spaced away from the mount fixture 12 in a vibration input direction, i.e., the vertical direction as seen in FIG. 1, and a rubber elastic body 21 that is disposed between the mount fixture 12 and the body fixture 17 and elastically connecting these fixtures 12, 17 such that one of axially opposite open ends of the body fixture 17 is fluid-tightly closed by the rubber elastic body 21. The support member 31 is concentrically secured press-fit into the other opposite open end of the body fixture 17 so that the support member 31 is integrally fixed to the other open end of the mount body 11. In the following description, the vertical and lateral directions of the components of the vibration damping device 10 shall be conformed to the vertical and lateral direction as seen in FIGS. 1-3, respectively.

The mount fixture 12 has an upper portion 13 of solid cylindrical configuration and a lower portion 14 of inverted frustoconical configuration, as integral parts. This mount fixture 12 may be formed by forging or the like. The mount fixture 12 is formed with a tapped hole 15 open in a central portion of its upper face and extends to the vicinity of the tip end of the lower portion 14. On the other hand, the body fixture 17 has a cylindrical portion 18 of hollow cylindrical configuration and an annular flange portion 19 as integral parts. This body fixture 17 may be formed of a plate blank by pressing, e.g., by drawing. The lower end portion of the cylindrical portion 18 is slightly bent axially inwardly, thereby providing an inward bent portion 18a. This inward bent portion 18a may be formed through a drawing operation executed after the support member 31 being secured press fit into a bore of the cylindrical portion 18.

The rubber elastic body 21 protrudes axially upwardly from the upper end of the body fixture with a generally frustoconical configuration, while being secured at its axially lower, outer circumferential surface into an inner circumferential surface of the cylindrical portion over the entire circumference thereof, in order to provide a fluid-tight closure to the upper open end of the body fixture 17. The rubber elastic body 21 has a shoulder portion 22 at an axially medial portion of the inner circumferential surface thereof, extending continuously in the circumferential direction, and has a thin rubber coating layer portion 23 situated on the axially lower side of the shoulder portion 22, and held in close contact onto the inner circumferential surface of the body fixture 17. A boundary between the shoulder portion 22 and the rubber coating layer portion 23 has a roundly concaved or inwardly curved shape. On the axially upper side of the shoulder portion 22, there is formed a tapered recess 24 of generally frustoconical configuration whose inside diameter gradually decreases as it moves from the shoulder portion 22 axially upwardly. The tapered recess 24 has a flat top wall 24a that is situated at the same height or axial position as the upper end of the body fixture 17. An inside space of the tapered recess 24 is contiguous to an inside space of the rubber coating layer portion 23 underneath, thereby providing a hollow portion 25 extending from the lower end to the upper end of the body fixture 17. At the tip end of the rubber elastic body 21, the mount fixture 12 is embedded such that only the upper end portion thereof projects axially outward from the tip end of the rubber elastic body 21, and the lower end face of the mount fixture 12 is held in contact with a flat plate portion 21a of the rubber elastic body 21.

The support member 31 includes a support base 32 of shallow cylindrical cup shape formed of a thin metallic plate, and a central rubber support in the form of a rubber pillar portion 36 of generally frustoconical configuration, which is bonded to an upper flat face of the support base 32 through vulcanization of a rubber material for forming thereof. The support base 32 includes a disk plate portion 33 and a cylindrical portion 34 formed by bending at right angles a peripheral portion of the disk plate portion 33 in a direction opposite to the projecting direction of the rubber pillar portion 36. An air hole may be formed through the disk plate portion 33, as needed. A boundary between the disk plate portion 33 and the cylindrical portion 34 has an arcuate configuration, thereby providing a curved portion 35. The cylindrical portion 34 has an outside diameter slightly larger than an inside diameter of the rubber coating layer portion 23, and the curved portion 35 has an outside profile conforming to an inside profile of the shoulder portion 22. The rubber pillar portion 36 of frustoconical configuration has a height dimension that is slightly larger than an axial distance between the shoulder portion 22 and the flat top wall 24a. The support member 31 is fixedly assembled with the mount body 1I such that the support base 32 is secured press fit into a bore of the rubber coating layer portion 23 of the body fixture 17 to be held in abutting contact with the shoulder portion 22, and the rubber pillar portion 36 is disposed substantially concentrically within the hollow portion 25, while being compressed with its tip end face held in abutting contact with the flat top wall 24a of the rubber elastic body 21. The tip end portion of the rubber pillar portion 36 is a generally flat face extending in a direction perpendicular to an opposing direction in which the metallic mount fixture 12 and the support member 31 are opposed to teach other, and is superimposed in a non-bonded state against the metallic mount fixture 12 via the flat top wall 24a of the rubber elastic body 21. With this arrangement, it may possibly expected to generate a slip between the flat face of the rubber pillar portion 36 and the flat top wall 24a, during input of vibration in the axis-perpendicular direction, further permitting further prevention of increase of the spring constant in the axis perpendicular direction.

As is apparent from FIG. 2, the mount body 11 may be formed through vulcanization molding where a rubber material for forming the rubber elastic body 23 is injected into a given mold (not shown) in which the mount fixture 12 and the body fixture 17 have been set, and then vulcanized and bonded to the fixtures within the mold. Likewise, as shown in FIG. 3, the support member 31 may be formed through vulcanization molding where a rubber material for forming the rubber pillar portion 36 is injected into a given mold (not shown) in which the support base 12, and then vulcanized and bonded to the support base 12. After the support member 31 is secured press fit into the bore of the cylindrical portion 18 of the mount body 11, the cylindrical portion 18 is subjected to a drawing operation in order to form the inward bent portion 18a. Thus, there is obtained the vibration damping device 10 of construction according to the present embodiment.

The vibration damping device 10 of construction as described above may be installed on an automotive vehicle, for example, such that the mount fixture 12 is superimposed against one of two members of a vibration system, e.g., an engine bracket (not shown), and fixed to the engine bracket by means of a mounting bolt threaded into a mounting hole of the engine bracket as well as the tapped hole 15 of the mount fixture 12, while the body fixture 17 is fixed to the other member of the vibration system, e.g., a body of the vehicle, via a suitable bracket (not shown).

In the vibration damping device 10 of construction according to the first embodiment of the invention, the vibration damping device 10 will be installed on the vehicle in a vertical attitude, i.e., with its center axis conforming to the vertical direction, i.e., a vibration input direction. Since the rubber pillar portion 36 in addition to the rubber elastic body 21 is arranged in the vertical direction, the vibration damping device 10 will exhibit an enhanced spring constant in the vertical direction. With this regards, since the rubber pillar portion 36 undergoes shear deformation with respect to input vibration in its diametric directions e.g., in the driving and lateral direction of the vehicle, the presence of the rubber pillar portion 36 does not impact on the spring constant of the vibration damping device 10 in such diametric directions. Accordingly, the vibration damping device 10 is capable of exhibiting damping effect with respect to engine shakes or other low frequency vibrations. Further, the rubber pillar portion 36 has a frustoconical configuration, making it possible to considerably lower the spring constant in the driving or lateral direction with respect to the spring constant in the vertical direction. Accordingly, engine idling vibrations effectively attenuated, assuring a good driving comfort of the vehicle. Besides, the rubber pillar portion 36 can be disposed within the hollow space 25 of the body fixture 17, without needing enlargement of the overall size of the vibration damping device 10, making it possible to considerably minimize an installation space for the vibration damping device 10, ensuring a readily installation of the vibration damping device 10 within a limited space such as engine room of the vehicle.

In the vibration damping device 10 of construction according to the first embodiment of the invention, the lower end face of the rubber pillar portion 36 is bonded through vulcanization of a rubber material for forming thereof to the upper face of the support base 32, and is formed separately from the rubber elastic body 21. This arrangement makes it possible to use the mount body 11 produced as a component of a fluid-filled vibration damping device similarly in the vibration damping device 10 of the present invention. This is very convenient to share the same component with different kinds of vibration damping devices without needing any modification in design of these devices, making it possible to provide a combination type vibration damping device capable of changing its damping characteristics by suitably selecting a suitable unit of non-fluid-filled type or fluid-filled type. Especially, by utilizing the mount body 11 for a small production vibration damping device, a desired vibration damping device will be produced in a very short period of time, with a relatively economical cost. Additionally, suitable modifications in shape and material of the rubber pillar portion 36 makes it possible to freely arrange damping characteristics of the vibration damping device 10 depending on applications.

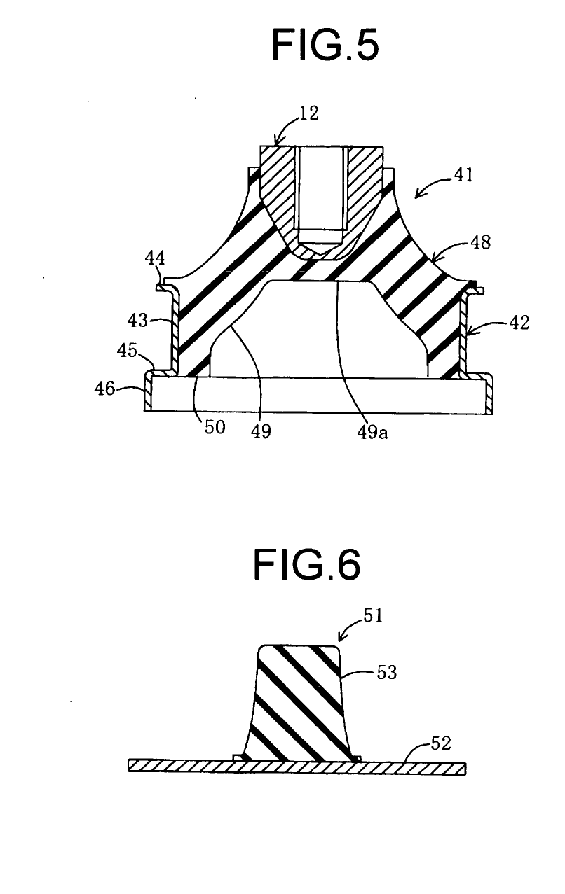

Referring next to FIG. 4, there is shown in axial cross section a vibration damping device 10A of construction according to a second embodiment of the present invention. FIG. 5 and FIG. 6 show in axial cross section a mount body 41 and a support member 51 of the vibration damping device 10A. The mount body 41 has a cylindrical portion 43 whose axial length is an approximately half of the cylindrical portion 18 of the vibration damping device 10 of the first embodiment, and a flange portion 44 is formed at an axially upper end portion of the cylindrical portion 43. An axially lower end portion of the cylindrical portion 43 is bent at right angles toward radially outwardly, thereby providing an annular horizontal portion 45 extending radially outwardly by a given slight distance. An outer peripheral portion of the annular horizontal portion 45 is then bent at right angles toward axially downwardly, thereby providing a large-diameter portion 46 extending axially outwardly by a given slight distance. A rubber elastic body 48 is different from the rubber elastic body 21 of the illustrated vibration damping device 10 in that the rubber elastic body 48 consists solely of the upper side of a bottom portion 50 thereof, which corresponds to a horizontal flat face of the shoulder portion 22 of the rubber elastic body 21, and has a tapered recess 49 of similar configuration of the tapered recess 23 in the rubber elastic body 21.

The support member 51 includes a support base 52 in the form of a thin disk-like metallic plate, and a rubber pillar portion 53 that is bonded by vulcanization to the upper face of the support base 52, like the rubber pillar portion 36 in the first embodiment. The support member 51 is assembled with the mount body 41 such that the support base 52 is inserted into the large diameter portion 46 of the body fixture 42 of the mount body 41, and is held in abutting contact with the horizontal portion 45, while the rubber pillar portion 53 is held in compression abutting contact at a tip end face thereof with a flat top wall 49a of the rubber elastic body 48. With this state, the tip end portion of the large-diameter portion 46 is fold back to form a fold back portion 47 that is forcedly engaged with the support base 52, whereby the support member 51 is firmly secured to the body fixture 42. Thus, there is provided the vibration damping device 10A of construction according to the second embodiment of the invention.

The vibration damping device 10A of construction according to the second embodiment will enjoy the same advantages of the invention, as described above with respect to the vibration damping device 10 of the first embodiment. The vibration damping device 10A may be modified to have a mounting bolt projecting from the support base 52 in a direction opposite to the disk plate portion 53 in advance. This mounting bolt may be used for attaching the support base 52 to the body of the vehicle or other possible member of the vibration system, instead of the body fixture 42. This arrangement permits a further decrease in the required space for installation of the vibration damping device 10A.

In the foregoing first and second embodiments, the rubber pillar portion 36, 53 is held in abutting contact bonded at its upper end face to the flat top wall 24a, 49a of the rubber elastic body 21, 48. Alternatively, the rubber pillar portion 36, 53 may be directly held in abutting contact with the mount fixture 12, depending on the fixing state of the mount fixture 12 to the rubber elastic body 21, 53.

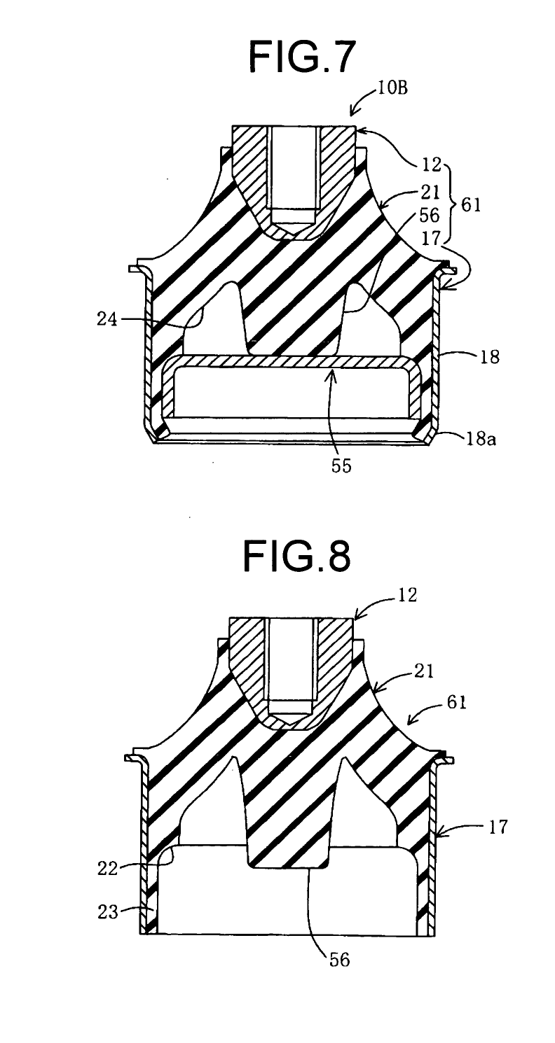

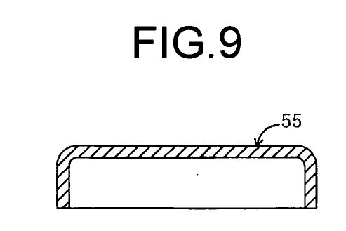

Referring next to FIG. 7, there is shown in axial cross section a vibration damping device 10B of construction according to a second embodiment of the present invention. FIG. 8 and FIG. 9 show in axial cross section a mount body 61 and a support base 55 of the vibration damping device 10B. The mount body 61 is similar to the mount body 11 in construction of the mount fixture 12, the body fixture 17 and the rubber elastic body 21, but is different in that the rubber pillar portion 56 is integrally formed with the rubber elastic body 21 so as to project from the flat top wall 24a of the rubber elastic body 21. The support base 55 has the same configuration as the support base 32 of the support member 31. In the vibration damping device 10B, the support base 55 is secured press fit into the bore of the rubber coating layer portion 23 of the body fixture 17, and is held in abutting contact with the shoulder portion 22. With the support member 51 assembled with the mount body 61 as stated above, the cylindrical portion 18 of the body fixture 17 is subjected to a drawing operation, to thereby form the inward bent portion 18a. Thus, the vibration damping device 10B is obtained.

In the vibration damping device 10B of construction of the third embodiment, the rubber pillar portion 56 is integrally bonded at its upper end face with the flat plate portion 21a of the rubber elastic body 21, thereby being integrated with the rubber elastic body 21, while being forcedly pressed at its lower end face against the support base 55. That is, the structure of the rubber pillar portion 56 is opposite to that of the rubber pillar portion 36 in the first embodiment where the rubber pillar portion 36 is bonded at its lower end face to the support base 55 while being forcedly pressed at its upper end face against the mount fixture 12.

Like in the first embodiment, the vibration damping device 10B of construction according to the third embodiment of the invention is capable of enhancing its spring constant in the vertical direction, while restricting increase in its spring constant in the vehicle driving or lateral directions. Therefore, the vibration damping device 10B will exhibit damping effects not only engine shakes but also engine idling vibration. Further, the vibration damping device 10B requires a considerably small space for installation thereof, thereby permitting a readily installation of the device 10B within a limited space, such as an engine room of the vehicle. In addition, since the rubber pillar portion 56 is integrally formed with the rubber elastic body 21, it is possible to form these two parts in a single vulcanization process, thereby reducing a cost for the vulcanization molding.

Alternatively, the vibration damping device 10B may employ a support base in the form of a thin disk-like metallic plate, instead of the support base 55, and may be arranged to directly support the thin disk support base by the lower end portion of the body fixture 17, like in the second embodiment. While the rubber pillar portion 56 is integrally bonded at one axial end face to the rubber elastic body 21 so as to project therefrom, in the third embodiment, the rubber pillar portion 56 may be directly bonded to and projects from the mount fixture 12, depending on the bonding construction of the rubber elastic body 21 with respect to the mount fixture 12. Even in this case, the rubber pillar portion 56 and the rubber elastic body 21 may be formed simultaneously in the single vulcanization process.

While the rubber pillar portion in each illustrated embodiment is generally concentrically disposed within the hollow portion of the second mounting member, with a radial spacing disposed between its outer circumferential surface and an inner circumferential surface of the rubber elastic body, the present invention includes a central rubber support that is disposed within the hollow space of the second mounting member to fill the space. This type of central rubber support may be formed by cutting a circular slit into the bottom face of the rubber elastic body over a given axial length, to thereby separate an outer circumferential surface of a central rubber support portion from the rubber elastic body, for example.

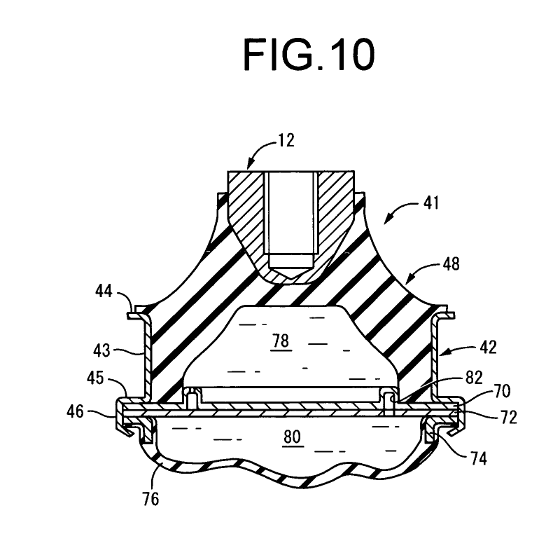

The aforementioned combination type vibration damping device may be embedded by utilizing the mount body 41 shown in FIG. 5 as a common integral vulcanization product, and combining the mount body 41 by the selected one of the non-fluid filled type unit as shown in FIG. 6, for example, and the fluid-filled type unit. FIG. 10 shows by way of example the combination type vibration damping device wherein the fluid-filled type unit is selected. Described in detail, the fluid-filled type unit includes an orifice defining member 70 and an partition member 72, which are both made of metal by pressing and superimposed to each other to define therebetween an orifice passage 82. These two members 70, 72 are superimposed against the lower end face of the rubber elastic body 48. A flexible layer 76 is disposed underneath of the partition member 72 with its peripheral edge fitted onto the peripheral edge of the partition member 72 via a generally annular fixing member 74. With this state, the large diameter portion 46 is bent radially inward direction, thereby fluid-tightly affixing the orifice defining member 70, the partition member 72, and the fixing member 74 against the metallic body fixture 42, through caulking fixation. Thus, there are formed a pressure-receiving chamber 78 partially defined by the rubber elastic body 48 on the upper side of the partition member 72, and an equilibrium chamber 80 partially defined by the flexible layer 76 on the lower side of the partition member 72. These chambers 78, 80 are filled with a non-compressible fluid. Since the orifice passage 82 are open at its opposite ends to the pressure-receiving chamber 78 and the equilibrium chamber 80, respectively, these two chambers 78, 80 are held in fluid communication through the orifice passage 82. The vibration damping device selecting the fluid-tilled type unit of construction as described above is able to exhibit vibration damping effect based on flow action of the non-compressible fluid like in the known fluid filled vibration damping device.

It is also to be understood that the present invention may be embodied with various other changes, modifications and improvements, which may occur to those skilled in the art, without departing from the spirit and scope of the invention defined in the following claims.

While the present invention has been described in its preferred embodiments with a certain degree of particularity, for illustrative purpose only, it is to be understood that the invention is by no means confined to the precise details of the illustrated embodiment, but may be suitably modified in configuration of the mount fixture, the body fixture, the rubber elastic body, the rubber pillar portion, for example. While not given individually herein, the present invention may be reduced to practice in various other modes incorporating variations, modifications and improvements which would be apparent to those skilled in the art, and these embodiments will of course fall within the scope of the invention insofar as they do not depart from the spirit thereof.

As is apparent from the foregoing description, the vibration damping device of the present invention is capable of enhancing its spring constant in the vibration input direction, i.e., in the vertical direction, while restricting the enhancement of the spring constant in the vehicle driving and lateral direction, thereby effectively attenuating engine idling vibration as well as engine shakes. Further, since the present vibration damping device is small in overall size with a simple construction, it will be advantageously utilized as an engine mount or other mounts needing a small installation space.

While an anti-load strength of the rubber elastic body with respect to an axial load is a considerable problem in the vibration damping device of non-fluid filled type, especially if the rubber elastic body has an outside profile of tapered configuration in order to reduce its spring constant in the axis perpendicular direction, and is resultantly more likely to suffer from buckling of the rubber elastic body. This problem typical of the non-fluid filled vibration damping device is advantageously solved by the present invention, without adverse impact on the spring characteristics of the rubber elastic body in the axis perpendicular direction.

1. A vibration damping device interposed between two members of a vibration system, comprising:
a first mounting member fixable to one of the two members of the vibration system;
a second mounting member fixable to an other of the two members of the vibration system, and having a hollow cylindrical portion that is substantially concentrically disposed to and spaced away from the first mounting member in a vibration input direction;
a rubber elastic body interposed between and elastically connecting the first and second mounting member such that a fluid-tight closure is provided to one open end of the cylindrical portion of the second mounting member, and a hollow portion extends from the rubber elastic body to an other open end of the cylindrical portion within the second mounting member, the rubber elastic body having a tapered outer circumferential surface whose diameter is gradually decreasing as it moves from the one open end of the cylindrical portion of the second mounting member toward the first mounting member;
a support member fixedly assembled with the second mounting member from a side of the other open end of the cylindrical portion of the second mounting member so as to extend in an axis-perpendicular direction of the second mounting member; and
a central rubber support disposed within the hollow portion of the second mounting member such that the central rubber support extends in an axial direction of the second mounting member and is compressed between opposite faces of the first mounting member and the support member,
wherein at least one of axially opposite end faces of the central rubber support is superimposed in a non-bonded state against an axially opposing member with a generally flat face thereof extending in a perpendicular direction to a direction in which the first mounting member and the support member are opposed to each other, and
wherein an outer circumferential surface of the central rubber support is not bonded to any other member over an entire axial length thereof.

2. A vibration damping device according to claim 1, wherein an other one of axially opposite end faces of the central rubber support is integrally bonded to one of the first mounting member and the support member.

3. A vibration damping device according to claim 1, wherein the one of axially opposite end faces of the central rubber support is superimposed in the non-bonded state against the first mounting member via the rubber elastic body, and the other one of axially opposite end faces of the central rubber support is integrally bonded to the support member.

4. A vibration damping device according to claim 1, wherein the support member is formed of a disk shaped plate member of metal.

5. A vibration damping device according to claim 4, wherein the support member is secured press fit into the cylindrical portion of the second mounting member via a rubber coating layer.

6. A vibration damping device according to claim 1, wherein the support member is at least partially defined by the other member of the vibration system.

7. A vibration damping device according to claim 1, wherein a radial spacing is formed between the outer circumferential surface of the central rubber support and the inner circumferential surface of the hollow portion of the second mounting member.

8. A vibration damping device according to claim 1, wherein the rubber elastic body has a generally frustoconical configuration having a recess open in a large-diameter end portion thereof, and is bonded at a small diameter end portion thereof to the first mounting member, and at an outer circumferential surface of the large-diameter end portion thereof to an inner circumferential surface of the cylindrical portion of the second mounting member such that the recess partially defines the hollow portion of the second mounting member, the central rubber support being disposed within the recess with a radial spacing between the outer circumferential surface of the central rubber support and the inner circumferential surface of the hollow portion over an entire axial length of the central rubber support.

9. A vibration damping device according to claim 1, wherein the central rubber support has a pillar configuration.

10. A vibration damping device according to claim 1, wherein the central rubber support has a tapered pillar configuration.

11. A vibration damping device according to claim 1, wherein the central rubber support has a frustoconical configuration.

12. A vibration damping device according to claim 1, further comprising an other central rubber support disposed within the hollow portion of the second mounting member such that the other central rubber support extends in an axial direction of the second mounting member and is compressed between opposite faces of the first mounting member and the support member, wherein the central rubber support and the other central rubber support are integrally bonded at first axial end faces thereof to and project from the first mounting member and the support member, respectively, and are superimposed against together at second axial end faces thereof in the non-bonded state.

13. A vibration damping device according to claim 1, wherein the second mounting member is bonded to the other of the two members of the vibration system via a bracket.

14. A combination type vibration damping device for automotive vehicles requiring different damping characteristics, wherein a common integral vulcanization product defined by a following (A) is combined with selected one of a first unit defined by a following (B) and a second unit defined by a following (C), depending on the required damping characteristics of the vehicles to which the vibration damping device is installed:
(A) the common integral vulcanization product including a first mounting member, a second mounting member having a hollow cylindrical portion that is substantially concentrically disposed to and spaced away from the first mounting member in a vibration input direction, and a rubber elastic body interposed between and elastically connecting the first and second mounting members such that a fluid-tight closure is provided to one open end of the cylindrical portion of the second mounting member, and a hollow portion extends from the rubber elastic body to an other open end of the cylindrical portion within the second mounting member, the rubber elastic body having a tapered outer circumferential surface whose diameter is gradually decreasing as it moves from the one open end of the cylindrical portion of the second mounting member toward the first mounting member;
(B) the first unit including a support member fixedly assembled with the second mounting member from a side of the other open end of the cylindrical portion of the second mounting member so as to extend in an axis-perpendicular direction of the second mounting member; and a central rubber support disposed within the hollow portion of the second mounting member such that the central rubber support extends in an axial direction of the second mounting member and is compressed between opposite faces of the first mounting member and the support member, at least one of axially opposite end faces of the central rubber support being superimposed in a non-bonded state against an axially opposing member with a generally flat face thereof extending in a perpendicular direction to a direction in which the first mounting member and the support member are opposed to each other, and an outer circumferential surface of the central rubber support being not bonded to any other member over an entire axial length thereof; and
(C) the second unit including a flexible layer fluid-tightly closing the other open end of the cylindrical portion of the second mounting member to thereby form a fluid chamber filled with a non-compressible fluid within the second mounting member by utilizing the hollow portion, a partition member extending in the axis-perpendicular direction of the second mounting member and supported by the second mounting member such that the partition member partitions the fluid chamber into a pressure receiving chamber partially defined by the rubber elastic body and an equilibrium chamber partially defined by the flexible layer, and an orifice passage for fluid communication between the pressure receiving chamber and the equilibrium chamber.
